(19) United States
(12) Patent Application Publication
(10) Pub. No.: US 2016/0365639 A1
(43) Pub. Date: Dec. 15, 2016

(54) ANTENNA STRUCTURE

(71) Applicant: ARCADYAN TECHNOLOGY CORPORATION, Hsinchu (TW)

(72) Inventor: Chih-Yung Huang, Hsinchu (TW)

(21) Appl. No.: 15/004,452

(22) Filed: Jan. 22, 2016

(30) Foreign Application Priority Data
Jun. 12, 2015 (TW) 104119185

(51) Int. Cl. H01Q 9/18; H01Q 9/14; H01Q 1/52

(52) U.S. Cl. CPC H01Q 9/18; H01Q 1/52; H01Q 9/145

(57) ABSTRACT

An antenna structure is disclosed. The antenna structure includes a reference axis having a first direction; a signal-feeding terminal; and a radiating portion, including a first conductor extending from the signal-feeding terminal along the first direction to a first turning point; a second conductor extending from the first turning point across the longitudinal reference axis to a second turning point; a third conductor extending from the second turning point along the first direction to a third turning point; a fourth conductor extending from the third turning point across the reference axis to a fourth turning point; and a fifth conductor extending from the fourth turning point along a second direction opposite to the first direction.

### CROSS-REFERENCE TO RELATED APPLICATION AND CLAIM OF PRIORITY

The application claims the benefit of the Taiwan Patent Application No. 104119185 filed on Jun. 12, 2015 at the Taiwan Intellectual Property Office, the disclosures of which are incorporated herein in their entirety by reference.

### FIELD OF THE INVENTION

The present invention relates to an antenna structure, and more particularly to a printed dipole antenna structure.

### BACKGROUND OF THE INVENTION

Nowadays, various compact antennas have been developed and applied to various compact hand-held electronic devices (e.g. cellphones or notebook computers) or wireless transmission devices (e.g. access points (AP)). For example, the planar inverse-F antenna (PIFA) which is compact, has good transmission efficiency, and can be easily disposed on the inner wall of a hand-held electronic device, already exists, and is widely applied in various hand-held electronic devices, notebook computers or wireless communication devices for wireless communication.

In a conventional Lite antenna where the signal is fed from the center of the antenna, the length of the cable is longer, and the resonance is generated in the way of ground terminal coupling. This results in the disadvantages of lower efficiency, difficult welding and assembly, two-sided production and a high production cost.

In order to overcome the drawbacks in the prior art, an antenna structure is disclosed. The particular design in the present invention not only solves the problems described above, but also is easy to implement. Thus, the present invention has utility for the industry.

### SUMMARY OF THE INVENTION

The present invention discloses a printed dipole antenna for a wireless transmission device. The printed dipole antenna in the present invention is suitable for an antenna disposed outside the wireless transmission device. In addition, the antenna structure of the present invention is an atypical design; that is, the signal is not fed from the center of the antenna.

In accordance with one aspect of the present invention, an antenna structure is disclosed. The antenna structure includes a first reference axis having a longitudinal direction, a first side with respect to the first reference axis, and a second side opposite to the first side; a signal-feeding terminal; a radiating portion, including a first conductor configured at the first side, and extending from the signal-feeding terminal along the longitudinal direction to a first turning point; a second conductor extending from the first turning point across the first reference axis to a second turning point at the second side; a third conductor configured at the second side, and extending from the second turning point along the longitudinal direction to a third turning point; a fourth conductor extending from the third turning point across the first reference axis to a fourth turning point at the first side; and a fifth conductor configured at the first side, and extending from the fourth turning point along a first direction opposite to the longitudinal direction; a ground terminal configured to be separated from the signal-feeding terminal with a first gap; and a ground portion including a first ground conductor extending from the ground terminal.

In accordance with the above aspect, the radiating portion further includes a sixth conductor extending from the third conductor across the first reference axis to the first side, and the fifth conductor extends to a fifth turning point between the sixth conductor and the fourth turning point.

In accordance with the above aspect, the radiating portion further includes a seventh conductor extending from the fifth turning point toward the third conductor.

In accordance with the above aspect, the antenna structure further includes a substrate disposing thereon the signal-feeding terminal, the radiating portion, the ground terminal and the ground portion; the first gap; a second gap disposed between the first conductor and the first ground conductor, and connected to the first gap; a third gap disposed between the second conductor and the first ground conductor, and connected to the second gap; a fourth gap disposed between the sixth conductor and the second conductor; and a fifth gap disposed among the third conductor, the fourth conductor, the fifth conductor, the sixth conductor and the seventh conductor.

In accordance with the above aspect, the radiating portion has a length for determining an operating frequency of the antenna structure.

In accordance with the above aspect, the fourth gap is provided for adjusting an impedance of the antenna structure, and has a size depending on the length of the radiating portion.

In accordance with the above aspect, the second gap has a first: size depending on a second size of the radiating portion.

In accordance with the above aspect, the ground portion has a third size depending on the second size.

In accordance with the above aspect, the ground portion further includes a second ground conductor extending from the ground terminal along the first direction.

In accordance with the above aspect, the ground portion further includes a first portion located at the first side, and a second portion located at the second side.

In accordance with the above aspect, the ground portion is electrically insulated from the radiating portion.

In accordance with the above aspect, the second conductor is perpendicular to the first conductor.

In accordance with the above aspect, the third conductor is perpendicular to the second conductor, and parallel to the first conductor.

In accordance with the above aspect, the fifth conductor is parallel to the third conductor.

In accordance with the above aspect, the six conductor is perpendicular to the fifth conductor, and parallel to the second conductor.

In accordance with another aspect of the present invention, an antenna structure is disclosed. The antenna structure includes a reference axis having a first direction; a signal-feeding terminal; a radiating portion, including a first conductor extending from the signal-feeding terminal along the first direction to a first turning point; a second conductor extending from the first turning point across the reference axis to a second turning point; a third conductor extending from the second turning point along the first direction to a third turning point; a fourth conductor extending from the third turning point across the reference axis to a fourth turning point; and a fifth conductor extending from the fourth turning point along a second direction. opposite to the first direction; and a ground terminal configured to be separated from the signal-feeding terminal with a first gap.

In accordance with the above aspect, the antenna structure further includes a first side with respect to the reference axis; and a second side opposite to the first side.

In accordance with the above aspect, the radiating portion further includes a sixth conductor extending from the third conductor across the reference axis to the first side, and the fifth conductor extends to a fifth turning point between the sixth conductor and the fourth turning point.

In accordance with the above aspect, the antenna structure further includes a ground portion including a first ground conductor extending from the ground terminal.

In accordance with a further aspect of the present invention, an antenna structure is disclosed. The antenna structure includes a reference axis having a first direction; a signal-feeding terminal; and a radiating portion, including a first conductor extending from the signal-feeding terminal along the first direction to a first turning point; a second conductor extending from the first turning point across the longitudinal reference axis to a second turning point; a third conductor extending from the second turning point along the first direction to a third turning point; a fourth conductor extending from the third turning point across the reference axis to a fourth turning point; and a fifth conductor extending from the fourth turning point along a second direction opposite to the first direction.

The above objectives and advantages of the present invention will become more readily apparent to those ordinarily skilled in the art after reviewing the following detailed descriptions and accompanying drawings, in which:

### BRIEF DESCRIPTION OF THE DRAWINGS

FIG. 1(a) is a front view of an antenna structure according to one embodiment of the present invention;

FIG. 1(b) is a side view of the antenna structure in FIG. 1(a);

FIGS. 2(a)-2(c) are front views of an antenna according to one embodiment of the present invention;

FIG. 3 shows the relationship between the frequency and the return loss of the antenna structure according to one embodiment of the present invention; and

FIG. 4 shows the relationship between the frequency and the efficiency of the antenna structure according to one embodiment of the present invention.

### DETAILED DESCRIPTION OF THE PREFERRED EMBODIMENT

The present invention will now be described more specifically with reference to the following embodiments. It is to be noted that the following descriptions of the preferred embodiments of this invention are presented herein for the purposes of illustration and description only; they are not intended to be exhaustive or to be limited to the precise form disclosed.

The objective of the present invention is to provide an antenna structure, which can be operated alone on an external system without additional ground areas, is suitable for the electronic device of the wireless transmission device, and can be easily adjusted and modified according to the product design to achieve the appropriate application. The embodiments of the present invention can all be applied to the operating bands of LTE-Band 13 (746˜787 MHz), LTE-Band 17 (704˜746 MHz), LTE-Band 20 (791˜862 MHz), LTE-Band 5 (824˜894 MHz) and 3G-Band (860˜960 MHz). That is, the embodiments of the present invention can be applied to the operating bands of 698-960 MHz, or the band of the present invention can be slightly adjusted to be applied to the antenna of wireless communication devices with other operating bands other than the above-mentioned bands, in addition, the antenna structure of the present invention has an antenna efficiency of 59-60% in the operating bands of 698-960 MHz, which is quite superior antenna efficiency for a low-frequency antenna.

The present invention is a printed dipole antenna structure disposed on a substrate (e.g. a printed circuit board, PCB), wherein the antenna structure is formed by printing a microstrip line on one side of the substrate, and connecting the signal-feeding terminal and the ground terminal to the microstrip line. The position of the other side of the substrate corresponding to the microstrip line has no ground metal printed thereon. The substrate can be a multilayer substrate or a single-layer substrate without metal,

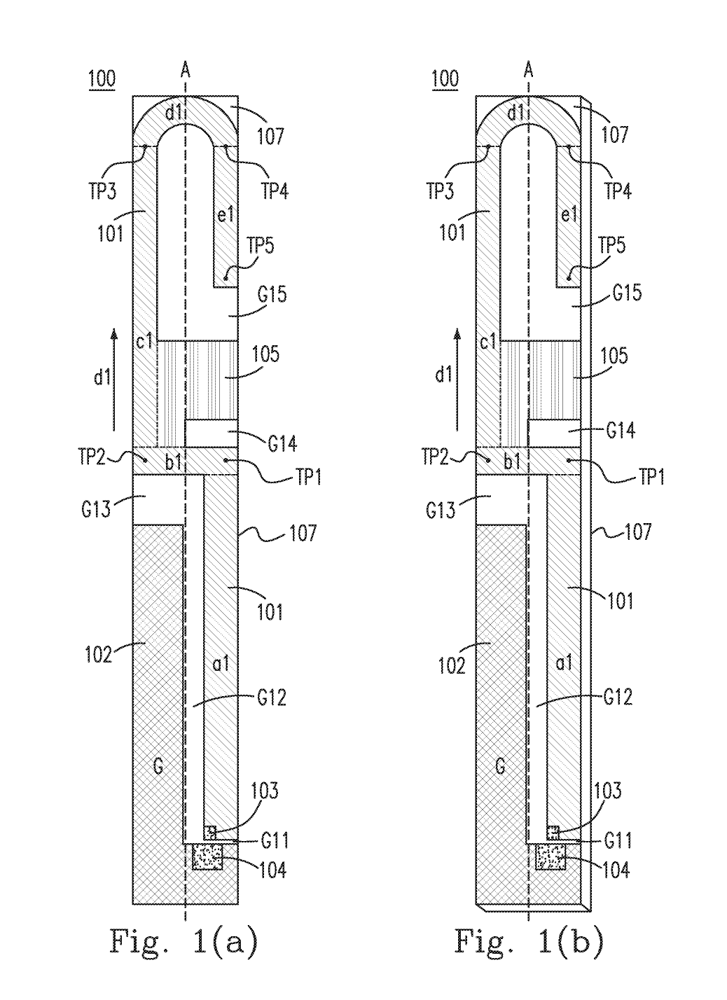

Please refer to FIGS. 1(a) and 1(b). FIG. 1(a) is a front view of an antenna 100 structure according to one embodiment of the present invention, and FIG. 1(b) is a side view of the antenna structure in FIG. 1(a). As shown in FIGS. 1(a) and 1(b), the antenna structure 100 includes a radiating portion 101, a grounding portion 102, a signal-feeding terminal 103, a ground terminal 104, a fourth gap G14 and a substrate 107. The antenna structure 100 further includes a first reference axis A, a first side with respect to the first reference axis A, and a second side opposite to the first side, wherein the first reference axis A has a longitudinal direction d1.

The radiating portion 101 includes a plurality of extending portions. The extending portions have a first conductor a1, a second conductor b1, a third conductor c1, a fourth conductor d1 and a fifth conductor e1. The first conductor a1 is configured at the first side, and extends from the signal-feeding terminal 103 along the longitudinal direction d1 to a first turning point TP1. The second conductor b1 extends from the first turning point TP1 across the first reference axis A to a second turning point TP2 at the second side. The third conductor c1 is configured at the second side, and extends from the second turning point TP2 along the longitudinal direction d1 to a third turning point TP3. The fourth conductor d1 extends from the third turning point TP3 across the first reference axis A to a fourth turning point TP4 at the first side. The fifth conductor e1 is configured at the first side, and extends from the fourth turning point TP4 along a first direction opposite to the longitudinal direction d1.

The second conductor b1 is perpendicular to the first conductor a1. The third conductor c1 is perpendicular to the second conductor b1, and parallel to the first conductor a1. The fifth conductor e1 is parallel to the third conductor c1.

The radiating portion 101 further includes a sixth conductor 105. The sixth conductor 105 extends from the third conductor c1 across the first reference axis A to the first side, and the fourth gap G14 is disposed between the sixth conductor 105 and the second conductor b1. The fifth conductor e1 extends to a fifth turning point TP5 between the sixth conductor 105 and the fourth turning point TP4.

The ground terminal 104 is configured to be separated from the signal-feeding terminal 103 with a first gap G11. The ground portion 102 further includes a first ground conductor G extending from the ground terminal 104.

In addition to the first gap G11 between the first conductor a1 and the first ground conductor G, the antenna structure 100 further includes a second gap G12, a third gap G13 and a fifth gap G15. The second gap G12 is disposed between the first conductor al and the first ground conductor G, and connected to the first gap G11. The third gap G13 is disposed between the second conductor b1 and the first ground conductor G, and connected to the second gap G12. The fifth gap G15 is disposed among the sixth conductor 105, the third conductor c1, the fourth conductor d1 and the fifth conductor e1.

The radiating portion 101 further includes an extending portion. (not shown). The extending portion has a seventh conductor (not shown) extending from the fifth turning point TP5 toward the third conductor c1. In addition, the seventh conductor is perpendicular to the fifth conductor e1, and parallel to the second conductor b1.

The ground portion 102 further includes a second ground conductor (not shown) extending from the ground terminal 104 along the first direction. The second ground conductor includes a first portion located at the first side, and a second portion located at the second side.

The length of the radiating portion 101 determines the operating frequency of the antenna structure 100. The fourth gap G14 is provided for adjusting the impedance of the antenna structure 100 so that the voltage standing wave ratio (VAWR) of the antenna structure 100 can reach the standard and requirements of the industry. In addition, the size of the fourth gap G14 depends on the length of the radiating portion 101. The size of the second gap G2 depends on the size of the radiating portion 101. The size of the ground portion 102 also depends on the size of the radiating portion 101.

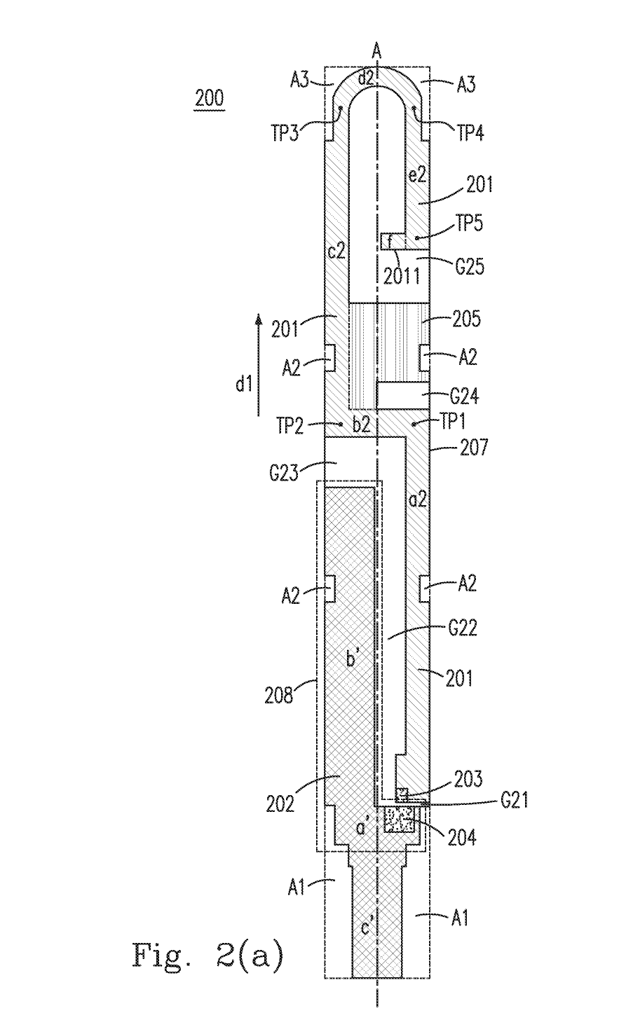

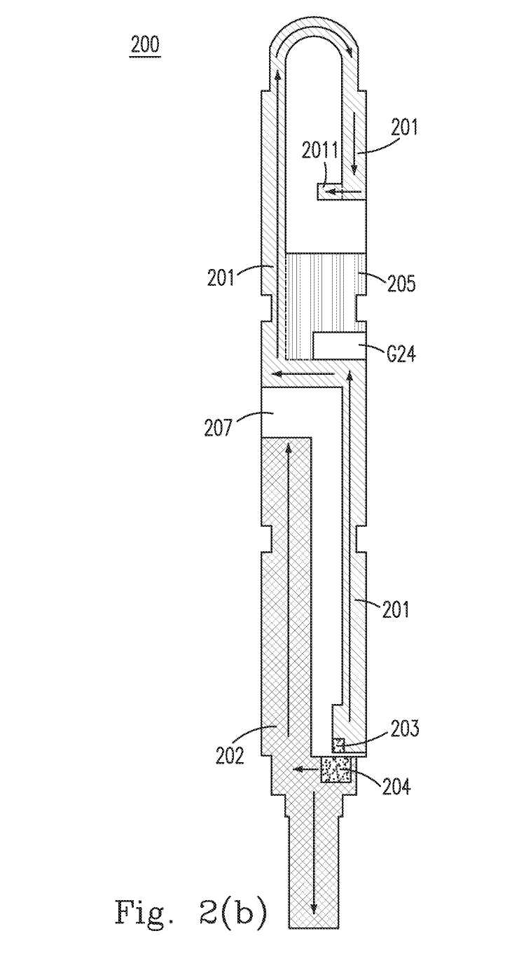

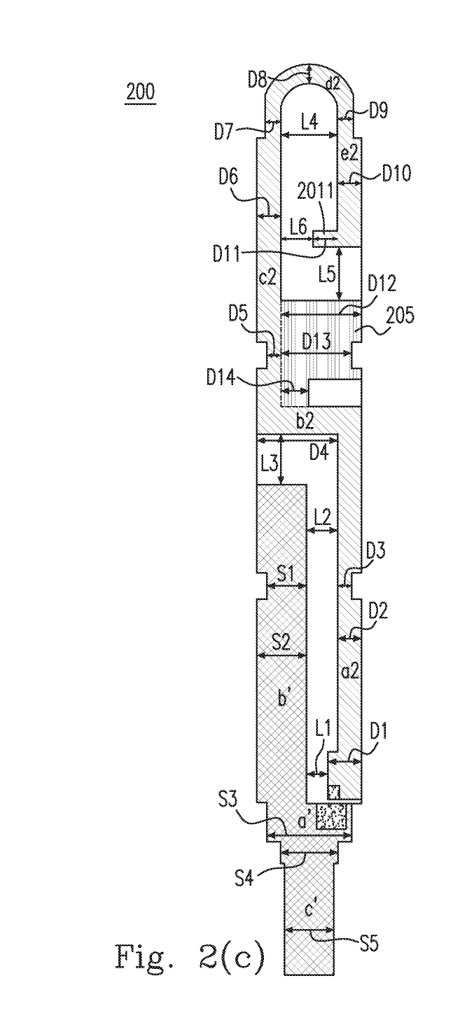

Please refer to FIGS. 2(a), 2(b) and 2(c), which are front views of an antenna 200 structure according to one embodiment of the present invention. As shown in FIGS. 2(a), 2(b) and 2(c), the antenna structure 200 includes a radiating portion 201, a grounding portion 202, a signal-feeding terminal 203, a ground terminal 204, a fourth gap G24 and a substrate 207. The antenna structure 200 further includes a first reference axis A, a first side with respect to the first reference axis A, and a second side opposite to the first side, wherein the first reference axis A has a longitudinal direction d1. The ground terminal 204 is configured to be separated from the signal-feeding terminal 203 with a first gap G21.

The radiating portion 201 includes a plurality of extending portions. The extending portions have a first conductor a2, a second conductor b2, a third conductor c2, a fourth conductor d2 and a fifth conductor e2. The first conductor a2 is configured at the first side, and extends from the signal-feeding terminal 203 along the longitudinal direction d1 to a first turning point TP1. The second conductor b2 extends from the first turning point TP1 across the first reference axis A to a second turning point TP2 at the second side. The third conductor c2 is configured at the second side, and extends from the second turning point TP2 along the longitudinal direction d1 to a third turning point TP3. The fourth conductor d2 extends from the third turning point TP3 across the first reference axis A to a fourth turning point TP4 at the first side. The fifth conductor e2 is configured at the first side, and extends from the fourth turning point TP4 along a first direction opposite to the longitudinal direction d1.

The radiating portion 201 further includes a sixth conductor 205. The sixth conductor 205 extends from the third conductor c2 across the first reference axis A to the first side, wherein the fifth conductor e2 extends to a fifth turning point TP5 between the sixth conductor 205 and the fourth turning point TP4.

The radiating portion 201 further includes an extending portion 2011 having a seventh conductor f. The seventh conductor f extends from the fifth turning point TP5 toward the third conductor c2, is perpendicular to the fifth conductor e2, and is parallel to the second conductor b2. The extending portion is designed to increase the length of the radiating portion 201 to generate the operating frequency to be used, without increasing the overall size.

The radiating portion 201, the extending portion 2011, the ground portion 202, the signal-feeding terminal 203, the ground terminal 204 and the sixth conductor 205 are coplanar.

The ground portion 202 includes a first ground conductor 208 and a second ground conductor c′. The first ground conductor 208 extends from the ground terminal 204. The second ground conductor c′ also extends from the ground terminal 204, and includes a first portion located at the first side and a second portion located at the second side.

The first ground conductor 208 has a first conductor branch a′ and a second conductor branch b′. The first conductor branch a is parallel to the second conductor b2, and the second conductor branch b′ is parallel to the first conductor a2. There is a right angle between the first conductor branch a′ and the second conductor branch b′. The two sides of the first conductor branch a′ are connected to the second conductor branch b′ and the ground conductor c′.

The sizes of the radiating portion 201 and the ground portion 202 can vary with the case of the product designed, as the areas A1, A2, A3 in FIG. 2(a) show. The widths of the first conductor a2, the third conductor c2, the fourth conductor d2 and the fifth conductor e2 can be adjusted to fine-tune the efficiency and the return loss of the antenna structure 200. In addition, the area A1 does not significantly affect the impedance matching of the antenna structure 200, but the size of the fourth gap G24 significantly affects the impedance matching of the antenna structure 200.

As shown in FIG. 2(b), the design of the radiating portion 201 and the ground portion 202 causes the current paths (as the arrows show) of the first conductor a2 and the second conductor branch b′ to have an identical direction and be parallel to each other. This results in the coupling reaction of the current, thereby causing the antenna structure 200 to have efficiency that is up to 60% and stable in the frequency band of 698˜960 MHz.

As shown in FIGS. 2(a) and 2(b), in addition to the first gap G21 disposed between the first conductor a2 and the first ground conductor 208, the antenna structure 200 further includes a second gap G22, a third gap G23 and a fifth gap G25. The second gap G22 is disposed between the first conductor a2 and the first ground conductor 208, and connected to the first gap G21. The third gap G23 is disposed between the second conductor b2 and the first ground conductor 208, and is connected to the second gap G22. The fifth gap G25 is disposed among the sixth conductor 205, the third conductor c2, the fourth conductor d2, the fifth conductor e2 and the seventh conductor f.

According to one embodiment of the present invention, the total length of the first conductor a2, the second conductor b2, the third conductor c2, the fourth conductor d2, the fifth conductor e2 and the extending portion 2011 is greater than that of the first ground conductor 208 and the second ground conductor c′. The total length of the first conductor a2, the second conductor b2, the third conductor c2, the fourth conductor d2, the fifth conductor e2 and the extending portion 2011 is about 2 times the total length of the first ground conductor 208 and the second ground conductor c′.

As shown in FIG. 2(c), the first conductor a2 has a first distance D1, a second distance D2 and a third distance D3. The second conductor b2 has a fourth distance D4. The third conductor c2 has a fifth distance D5, a sixth distance D6 and a seventh distance D7. The fourth conductor d4 has an eighth distance D8. The fifth conductor e2 has a ninth distance D9 and a tenth distance D10. The extending portion 2011 has an eleventh distance D11. The sixth conductor 205 has a twelfth distance D12, a thirteenth distance D13 and a fourteenth distance D14.

The first distance D1 is greater than the second distance D2. The second distance D2 is greater than the third distance D3. The third distance D3 is less than half of the first distance D1. The first distance D1 is less than half of the fourth distance D4. The third distance D3 is approximately equal to the fifth distance D5. The sixth distance D6 is greater than the seventh distance D7. The eighth distance D8 is approximately equal to the fifth distance D5. The ninth distance D9 is approximately equal to the seventh distance D7. The tenth distance D10 is approximately equal to the sixth distance D6. The eleventh distance D11 is less than the first distance D1 but greater than the second distance D2. The twelfth distance D12 is approximately equal to the fourth distance D4. The thirteenth distance D13 is less than the twelfth distance D12. The fourteenth distance D14 is approximately equal to one-third of the fourth distance D4. The sum of the second distance D2 and the fourth distance D4 is equal to a total width, and the sum of the sixth distance D6 and the twelfth distance is also equal to the total width.

The second conductor branch b′ has a fifteenth distance S1 and a sixteenth distance S2. The first conductor branch at has a seventeenth distance S3. The second ground conductor c′ has a eighteenth distance S4 and a nineteenth distance S5.

The fifteenth distance S1 is less than the sixteenth distance S2. The fifteenth distance S1 is less than half of the seventeenth distance S3. The eighteenth distance S4 is less than the seventeenth distance S3 but slightly larger than the nineteenth distance S5. The seventeenth distance 53 is approximately equal to the thirteenth distance D13.

The second gap G22 has a twentieth distance L1 and a twenty-first distance L2. The third gap G23 has a twenty-second distance L3. The fourth gap G24 has a twenty-third distance L4, a twenty-fourth distance L5 and a twenty-fifth distance L6.

The twentieth distance L1 is less than the twenty-first distance L2, and less than half of the twenty-second distance. The twenty-third distance L4 is slightly greater than the twenty-fourth distance L5. The twenty-fifth distance L6 is slightly greater than half of the twenty-third distance L4. The sum of the sixth distance D6, the tenth distance D10 and the twenty-third distance L4 is equal to the total width. The sum of the sixteenth distance S2, the second distance D2 and the twenty-first distance L2 is also equal to the total width. The sum of the sixth distance D6, the twenty-fifth distance L6, the eleventh distance D11 and the tenth distance D10 is also equal to the total width.

The sixth distance D6 and the tenth distance D10 are less than half of the twenty-third distance L4. The second distance D2 is slightly less than the twenty-first distance L2. The twenty-first distance L2 is less than the sixteenth distance S2. The sixth distance D6 is approximately equal to the tenth distance D10, and greater than the twenty-fifth distance L6 or half of the eleventh distance D11.

In addition, the design of the signal-feeding terminal 203 and the ground terminal 204 causes the antenna structure 200 to have excellent operating efficiency in the LTE frequency band, without changing the overall size.

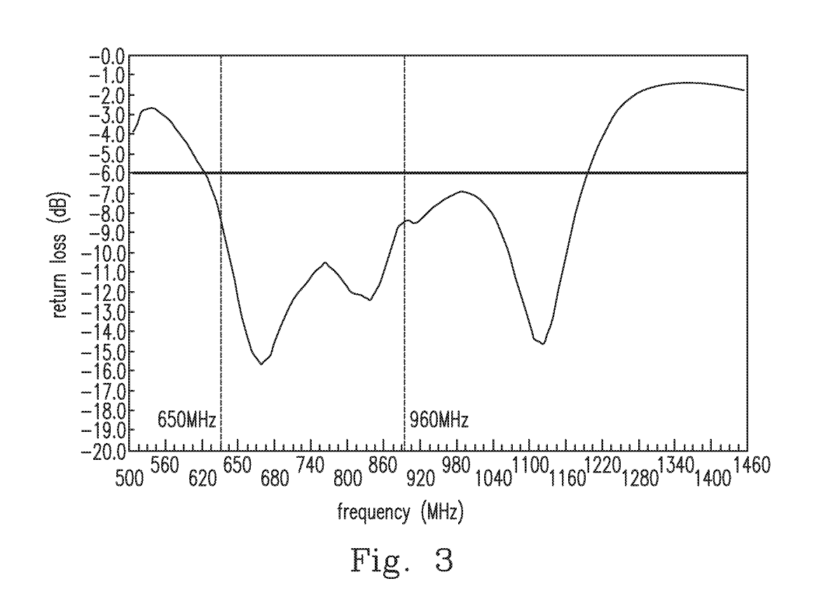

Please refer to FIG. 3, which shows the relationship between the frequency and the return loss of the antenna structure 200 according to one embodiment of the present invention. The vertical axis of FIG. 3 represents the return loss (unit: dB), and the horizontal axis represents the frequency (unit: MHz). As shown in FIG. 3, with the operating frequencies having a return loss of −6 dB, it can be seen that the antenna structure 200 has good impedance matching in the frequency band of 650-960 MHz.

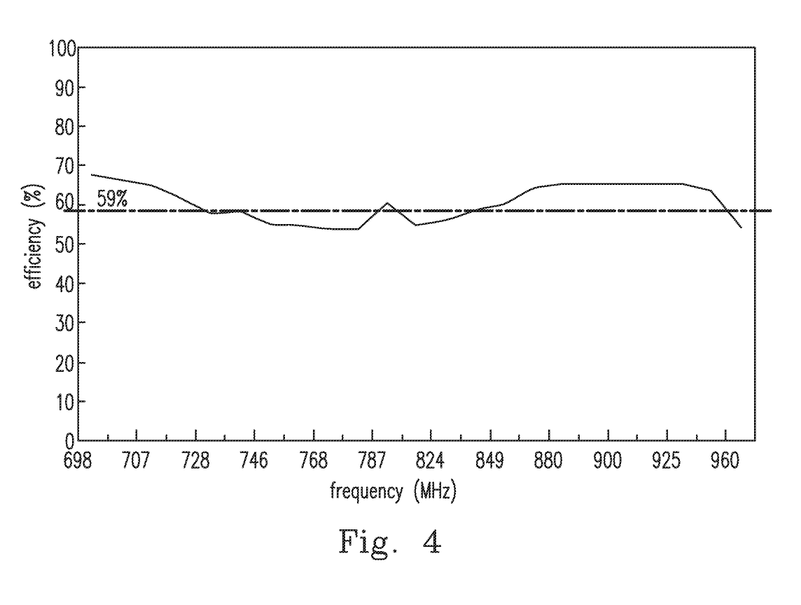

Please refer to FIG. 4, which shows the relationship between the frequency and the efficiency of the antenna structure according to one embodiment of the present invention. The vertical axis of FIG. 4 represents the efficiency (unit: %), and the horizontal axis represents the frequency (unit: MHz). As shown in FIG. 4, the efficiency of the antenna structure is up to 60% in the frequency band of 698-960 MHz.

In conclusion, the present invention discloses a printed dipole antenna structure which can be easily adjusted to achieve many product applications. The bandwidth of the conventional PIFA antenna is narrower, and so when it is applied, to a broadband system, the structure is complex, and frequency band fine-tuning is not easy to perform in different environments, in addition, if multi-system sharing can be achieved without adjusting the frequency band, the overall cost can be effectively reduced. Therefore, it is easy for the printed dipole antenna structure in the present invention to perform adjustments for the required frequency bands in different environments. Furthermore, because the printed dipole antenna structure in the present invention is manufactured by directly printing the antenna structure onto a printed circuit board, not only can the mold cost of the three-dimensional antenna be reduced, but also the costs of production and assembly also go down. Thus, the antenna structure in the present invention meets the needs of today's electronics industry which has the characteristic of low margins, can be used in wireless network devices in various environments, and can be easily applied to many different products. The idea behind the present invention is to extend the current path of the ground portion and the radiating path of the radiating portion in the same direction. This causes the antenna structure to achieve efficiency of nearly 60% in the region of the low-frequency LTE frequency band. In addition, the antenna signal is fed by being directly soldered to the signal-feeding terminal of the antenna with a 50Ω. Cable. The other end of the 50Ω Cable can be arbitrarily extended to an RF signal module terminal so that the antenna structure can be used with an independent printed circuit board without being connected to additional systems, or alternatively it can be used with a collocation of the system ground. Therefore, the antenna structure in the present invention also features an independent adjustment mechanism, which is suitable for many different applications.

While the invention has been described, in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all such modifications and similar structures.

What is claimed is:

1. An antenna structure, comprising:
a first reference axis having a longitudinal direction, a first side with respect to the first reference axis, and a second side opposite to the first side;
a signal-feeding terminal;
a radiating portion, including:
a first conductor configured at the first side, and extending from the signal-feeding terminal along the longitudinal direction to a first turning point;
a second conductor extending from the first turning point across the first reference axis to a second turning point at the second side;
a third conductor configured at the second side, and extending from the second turning point along the longitudinal direction to a third turning point;
a fourth conductor extending from the third turning point across the first reference axis to a fourth turning point at the first side; and
a fifth conductor configured at the first side, and extending from the fourth turning point along a first direction opposite to the longitudinal direction;
a ground terminal configured to he separated from the signal-feeding terminal with a first gap; and
a ground portion including a first ground conductor extending from the ground terminal.

2. The antenna structure as claimed in claim 1, wherein the radiating portion further includes a sixth conductor extending from the third conductor across the first reference axis to the first side, and the fifth conductor extends to a fifth turning point between the sixth conductor and the fourth turning point.

3. The antenna structure as claimed in claim 2, wherein the radiating portion further includes a seventh conductor extending from the fifth turning point toward the third conductor.

4. The antenna structure as claimed in claim 3, further comprising:
a substrate disposing thereon the signal-feeding terminal, the radiating portion, the ground terminal and the ground portion;
the first gap;
a second gap disposed between the first conductor and the first ground conductor, and connected to the first gap;
a third gap disposed between the second conductor and the first ground conductor_{;} and connected to the second gap;
a fourth gap disposed between the sixth conductor and the second conductor; and
a fifth gap disposed among the third conductor, the fourth conductor, the fifth conductor, the sixth conductor and the seventh conductor.

5. The antenna structure as claimed in claim 4, wherein the radiating portion has a length for determining an operating frequency of the antenna structure.

6. The antenna structure as claimed in claim 5, wherein the fourth gap is provided for adjusting an impedance of the antenna structure, and has a size depending on the length of the radiating portion.

7. The antenna structure as claimed in claim 4, wherein the second gap has a first size depending on a second size of the radiating portion.

8. The antenna structure as claimed in claim 7, wherein the ground portion has a third size depending on the second size.

9. The antenna structure as claimed in claim 1, wherein the ground portion further includes a second ground conductor extending from the ground terminal along the first direction.

10. The antenna structure as claimed in claim 10, wherein the second ground conductor includes a first portion located at the first side, and a second portion located at the second side.

11. The antenna structure as claimed in claim 1, wherein the ground portion. is electrically insulated from the radiating portion.

12. The antenna structure as claimed in claim 1, wherein the second conductor is perpendicular to the first conductor.

13. The antenna structure as claimed in claim 1, wherein the third conductor is perpendicular to the second conductor, and parallel to the first conductor.

14. The antenna structure as claimed in claim 1, wherein the fifth conductor is parallel to the third conductor.

15. The antenna structure as claimed in claim 1, wherein the sixth conductor is perpendicular to the fifth conductor, and parallel to the second conductor.

16. An antenna structure, comprising:
a reference axis having a first direction;
a signal-feeding terminal;
a radiating portion, including:
a first conductor extending from the signal-feeding terminal along the first direction to a first turning point;
a second conductor extending from the first turning point across the reference axis to a second turning point;
a third conductor extending from the second turning point along the first direction to a third turning point;
a fourth conductor extending from the third turning point across the reference axis to a fourth turning point; and
a fifth conductor extending from the fourth turning point along a second direction opposite to the first direction; and
a ground terminal configured to be separated from the signal-feeding terminal with a first gap.

17. The antenna structure as claimed in claim 16, further comprising:
a first side with respect to the reference axis; and
a second side opposite to the first side.

18. The antenna structure as claimed in claim 17, wherein the radiating portion further includes a sixth conductor extending from the third conductor across the reference axis to the first side, and the fifth conductor extends to a fifth turning point between the sixth conductor and the fourth turning point.

19. The antenna structure as claimed in claim 16, further comprising a ground portion including a first ground conductor extending from the ground terminal.

20. An antenna structure, comprising:
a longitudinal reference axis having a first direction;
a signal-feeding terminal; and
a radiating portion, including:
a first conductor extending from the signal-feeding terminal along the first direction to a first turning point;
a second conductor extending from the first turning point across the longitudinal reference axis to a second turning point;
a third conductor extending from the second turning point along the first direction to a third turning point;
a fourth conductor extending from the third turning point across the reference axis to a fourth turning point; and
a fifth conductor extending from the fourth turning point along a second direction opposite to the first direction.
